(19) United States
(12) Patent Application Publication
(10) Pub. No.: US 2024/0310791 A1
(43) Pub. Date: Sep. 19, 2024

(54) DEVICE AND WATCH

(71) Applicant: CASIO COMPUTER CO., LTD., Tokyo (JP)

(72) Inventor: Junichiro SUZUKI, Tokyo (JP)

(73) Assignee: CASIO COMPUTER CO., LTD., Tokyo (JP)

(21) Appl. No.: 18/602,679

(22) Filed: Mar. 12, 2024

(30) Foreign Application Priority Data
Mar. 14, 2023 (JP) 2023-039623

(51) Int. Cl. G04G 17/08; G04G 17/04; G04G 21/00

(52) U.S. Cl. CPC G04G 17/08; G04G 17/04; G04G 21/00

(57) ABSTRACT

According to one embodiment, a device includes: a case body including a peripheral wall portion; a cover frame provided on one side of the peripheral wall portion of the case body and made of a metal with an opening; a cover plate formed to have a plate shape and arranged in the opening of the cover frame; an vibration plate arranged on another side of the cover plate and made of metal; and a piezoelectric ceramic plate arranged on another side of the vibration plate, wherein an inner peripheral surface of the opening of the cover frame and an outer peripheral surface of the vibration plate are spaced apart from each other.

### CROSS-REFERENCE TO RELATED APPLICATIONS

This application is based upon and claims the benefit of priority from Japanese Patent Application No. 2023-039623, filed Mar. 14, 2023, the entire contents of which are incorporated herein by reference.

### FIELD

The present invention relates to a device and a watch.

### BACKGROUND

Jpn. Pat. Appln. KOKAI Publication No. 2009-8497 discloses a case device which includes an annular metal case body housing both a module and an antenna, and a glass back cover covering the case body and the back side of the module, and in which the back cover is fixed to the case body.

### SUMMARY

A device according to one embodiment of the present invention comprises: a case body including a peripheral wall portion; a cover frame provided on one side of the peripheral wall portion of the case body and made of a metal with an opening; a cover plate formed as a plate and arranged in the opening of the cover frame; an vibration plate provided on the other side of the cover plate and made of metal; and a piezoelectric ceramic plate arranged on the other side of the vibration plate, the inner peripheral surface of the opening of the cover frame and the outer peripheral surface of the vibration plate being spaced apart from each other.

### BRIEF DESCRIPTION OF THE DRAWINGS

FIG. 1 is a sectional view showing the structure of a watch according to the first embodiment.

FIG. 2 is a perspective view showing the structure of part of a watch case.

FIG. 3 is a sectional view showing the structure of a back cover portion of the watch case.

FIG. 4 is a sectional view in which part of FIG. 3 is enlarged.

FIG. 5 is a plan view showing the structure of the back cover portion.

### DETAILED DESCRIPTION

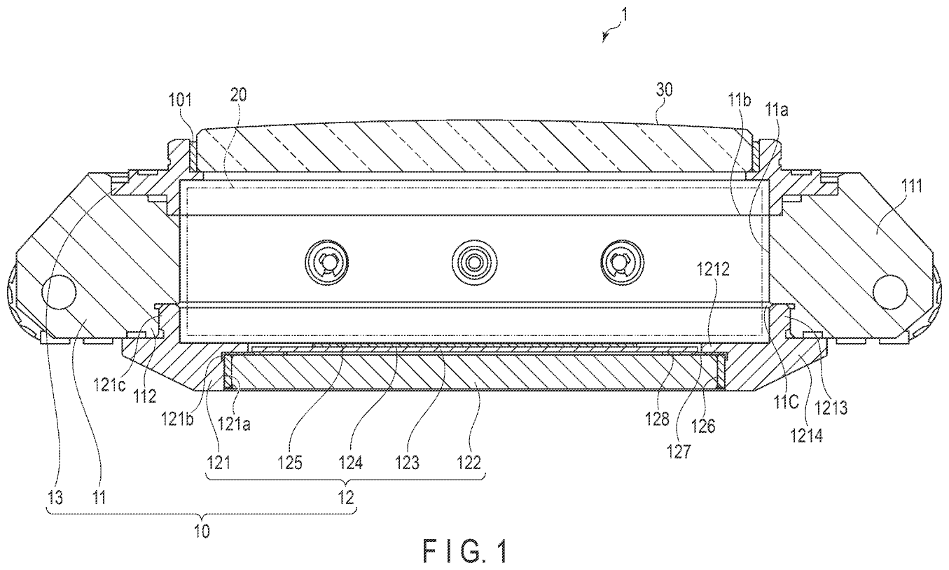

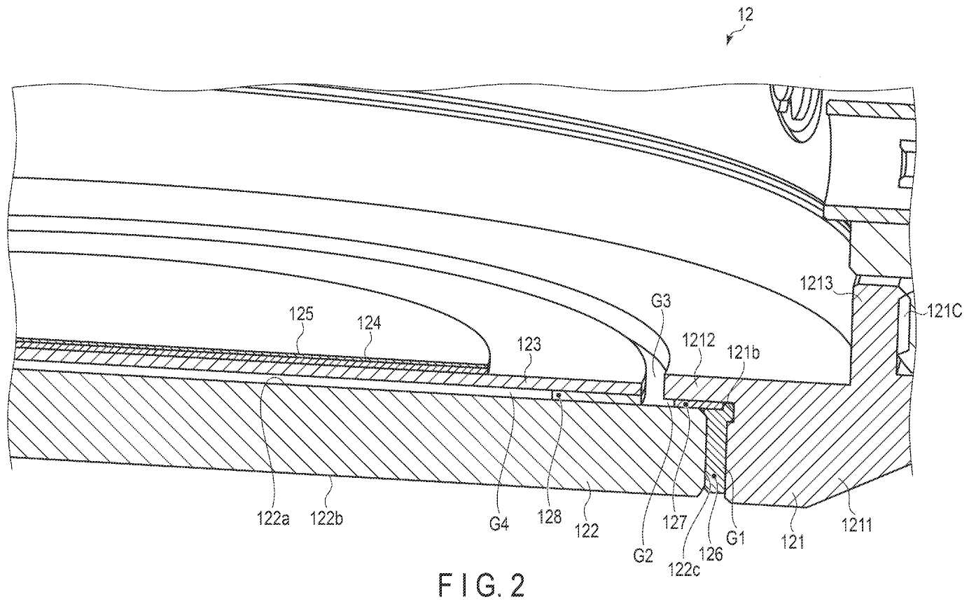

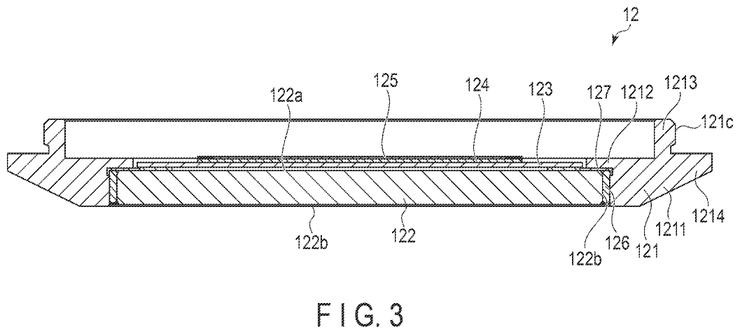

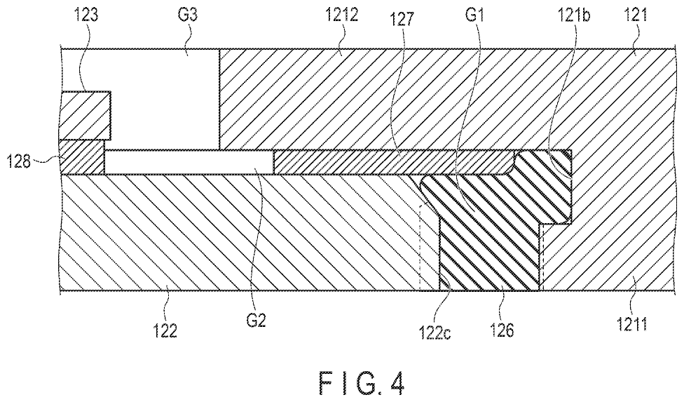

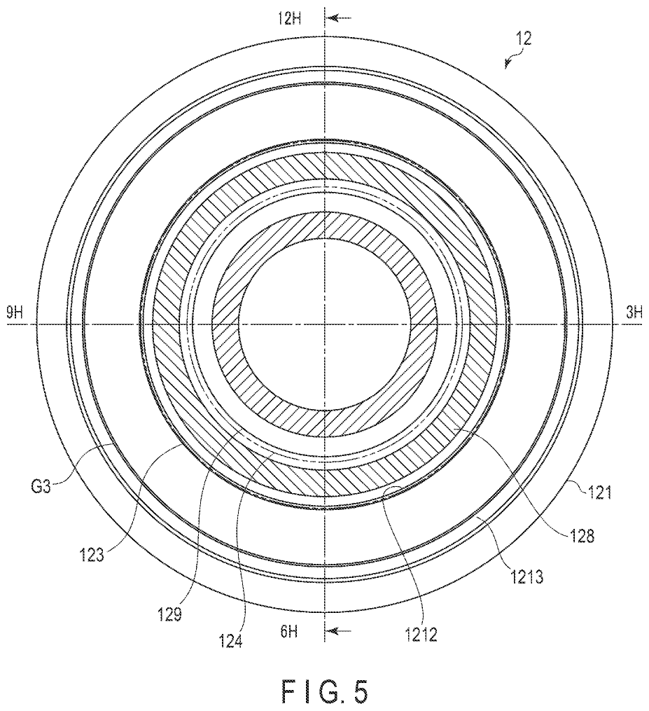

A watch according to the first embodiment of the present invention will now be described below with reference to FIG. 1 to FIG. 4. FIG. 1 is a sectional view showing the structure of the watch 1, FIG. 2 is a perspective view of a watch case, and FIG. 3 is a sectional view of the back cover portion of the watch case. FIG. 4 is an enlarged view of part of FIG. 3. FIG. 5 is a plan view showing the structure of the back cover portion. In each Figure, the structure is schematically shown, with the structure being enlarged, reduced, or omitted as appropriate.

As shown in FIG. 1 and FIG. 2, the watch 1 is, for example, a wristwatch. The watch 1 includes a watch case 10 serving as a device, a watch module 20 (module) provided in the watch case 10, and a cover 30 that covers the front side of the watch module 20. The watch 1 also includes a watch band connected to two positions of the outer periphery of the watch case 10 and a plurality of switches arranged on the outer periphery of the watch case 10.

Conventionally, a case device is known which includes an annular metal case body housing both a module and an antenna, and a glass back cover covering the back side of the case body and the module, and in which the back cover is fixed to the case body.

In such a case device, the receiving sensitivity of the antenna can be improved as compared with the case where the back cover is made of metal.

However, such a case device has a subject in that if a piezoelectric ceramic plate for producing sound is installed inside the back cover fixed to the metal case body, resistance increases due to the contact between a metal vibration plate for which the piezoelectric ceramic plate is provided and the metal case body, resulting in a decrease in the radio wave receiving sensitivity.

A description will now be given of a device and a watch which have been designed under the mentioned circumstances and which ensure excellent radio wave sensitivity.

A watch case 10 includes: a case body 11 formed to have a circular shape and arranged around the outer periphery of a watch module 20; a back cover portion 12 arranged on the back side of the watch module 20; and an exterior case 13. The case body 11 and the back cover portion 12 of the watch case 10 define a housing space 11a (housing portion) in which the watch module 20 is housed.

In the present embodiment, the watch 1 will be described, assuming that one side in one direction, toward which a main surface, opposed to the watch module 20, of a cover plate 122 constituting the bottom of the watch case 10 faces, is a back side, and the other side in the one direction, toward which the outer surface of the cover 30, such as a windshield member, faces, is a front side. For example, the main surface of the cover plate 122, which is the back side of the watch 1 and located opposite to the watch module 20, faces the arm on which the watch is to be worn. For example, the watch 1 is formed to have a circular shape having its central axis along one direction, and each of the case body 11, the back cover portion 12, the exterior case 13 and the cover 30 that constitute the watch case 10 is concentric or nearly concentric. It should be noted that the watch 1 and each member need not have a circular shape but may have an angular shape or another shape.

The case body 11 is made of a metal material such as titanium and has a cylindrical shape. The case body 11 includes a peripheral wall portion 111 having a housing space 11a (housing portion) in which the watch module 20 is provided. For example, in one direction along the central axis of the circle, the case body 11 has a front opening 11b covered with the cover 30 on the front side as the other side, and a back opening 11c covered with the back cover portion 12 on the back side as one side. The peripheral wall portion 111 has a cylindrical shape with an axial direction extending along one direction. The peripheral wall portion 111 is arranged on the outer periphery of the watch module 20.

The front side end and the back side end of the peripheral wall portion 111 are formed with steps and recesses for engaging with the exterior case 13 and the back cover portion 12. For example, a fastening portion 112, for which an engagement cylinder portion 1213 of the screw-back type back cover portion 12 is arranged, is formed on the back side edge of the inner peripheral edge of the peripheral wall portion 111. For example, the fastening portion 112 has a step and has an engagement structure, such as a threaded groove that engages with the engagement cylinder portion 1213. The corner portions of the front and back side ends of the outer peripheral surface of the peripheral wall portion 111 are chamfered to form tapered surfaces that are inclined with respect to the radial and axial directions of the circle.

The peripheral wall portion 111 houses the watch module 20 in the housing space 11a provided at the center. Part of the front side (inner peripheral side) of the peripheral wall portion 111 is covered with the exterior case 13, and part of the back side (inner peripheral side) of the peripheral wall portion 111 is covered with the back cover portion 12. A cover 30 is attached to the inner peripheral side of the exterior case 13 arranged on the front side of the peripheral wall portion 111, with a waterproof member 101, such as packing, interposed.

As shown in FIG. 1 to FIG. 5, the back cover portion 12 includes a cover frame 121, a cover plate 122, an vibration plate 123, a piezoelectric ceramic plate 124, and a covering plate 125. The back cover portion 12 further includes a first joining member 126 and a second joining member 127, which are provided between the cover frame 121 and the cover plate 122, a third joining member 128 which is provided between the vibration plate 123 and the cover plate 122, and a fourth joining member 129 which is provided between the piezoelectric ceramic plate 124 and the covering plate 125.

As one example, the members of each portion, including the cover 30, the case body 11, the cover frame 121, the cover plate 122, the vibration plate 123, the piezoelectric ceramic plate 124, and the covering plate 125, have a concentric shape; alternatively, they have similar angular shapes, such as an octagonal shape, which allow them to coincide with the outer shapes of target members to be assembled together. For example, the outer shape of the cover 30 coincides with the shape of the front opening 11b of the exterior case 13 arranged above the peripheral wall portion 111. It should be noted that the outer shape of the cover 30 need not be circular but square. Further, the outer shape of the front side of the back cover portion 12 (the outer shape of the engagement cylinder portion 1213 to be described later) coincides with that of the back opening 11c of the peripheral wall portion 111. Further, the cover plate 122 coincides with the inner peripheral surface of the cover frame 121 and has a small diameter, with a slight gap G1 provided. The vibration plate 123 has a small diameter, with a slight gap G3 provided between the vibration plate 123 and the inner peripheral surface of an inner flange portion 1212.

The cover frame 121 is made of metal and has a circular frame shape with an opening 121a at the center.

For example, the cover frame 121 integrally includes an annular frame base 1211 arranged around the outer periphery of the cover plate 122, an inner flange portion 1212 that protrudes inward into the opening from the front side end of the frame base 1211, and an engagement cylinder portion 1213 extending toward the front side from the frame base 1211.

The frame base 1211 is provided on the back side of the peripheral wall portion 111 and has an annular shape. The frame base 1211 has an opening 121a that serves as a through hole in which the cover plate 122 is provided. The inner peripheral surface of the frame base 1211 is opposed to the outer peripheral surface of the cover plate 122 and supports the outer periphery of the cover plate 122. An outer peripheral edge portion 1214 of the frame base 1211 extends in the outer peripheral direction from the base end portion of the engagement cylinder portion 1213 and is opposed to the back surface of the peripheral wall portion 111, for example.

The inner flange portion 1212 is formed as a thin plate. The inner flange portion 1212 is provided around the entire periphery of part of the opening of the frame base 1211, and is opposed to the front side surface of the outer peripheral edge of the cover plate 122, with a predetermined gap interposed. Specifically, the peripheral edge of the cover plate 122 is adhered to the back surface of the inner flange portion 1212 by means of a second joining member 127 such as double-sided adhesive tape. As shown in FIG. 4, the inner diameter of the inner flange portion 1212 is configured to be slightly larger than the outer diameter of the vibration plate 123, and a gap G3 is formed between the inner peripheral edge of the inner flange portion 1212 and the outer peripheral edge of the vibration plate 123.

A concave portion 121b, which is a peripheral groove formed along the peripheral direction, is formed at a corner portion (angular portion) at the base end of the inner flange portion 1212. The concave portion 121b serves as an escape portion in which packing and adhesive can be provided.

The engagement cylinder portion 1213 is a cylindrical member that projects from the frame base 1211 to the front side. For example, the engagement cylinder portion 1213 is formed to have a cylindrical shape. The engagement cylinder portion 1213 includes a fastening portion 121c fastened to the peripheral wall portion 111 of the case body 11. The fastening portion 121c includes a threaded portion formed, for example, on the outer peripheral surface of the engagement cylinder portion. The engagement cylinder portion 1213 is inserted into the back opening 11c of the case body 11 and fastened to the case body 11.

The cover plate 122 is a plate-like member that covers the back side of the case body 11 and the watch module 20. The cover plate 122 is made of a material having a higher magnetic permeability than that of the cover frame 121. For example, the cover plate 122 is made of translucent sapphire glass and constitutes the bottom of the watch case 10. A light shielding layer may be formed on the outer surface of the cover plate 122 by such a process as vapor deposition.

As shown in FIG. 3, the cover plate 122 is formed to have a disc shape having a pair of circular main surfaces 122a and 122b on the front and back sides and a circular outer peripheral surface 122c, and has a constant thickness, for example. The outer peripheral surface 122c is opposed to the inner peripheral surface of the opening 121a, with the first joining member 126 interposed. For example, the outer diameter of the cover plate 122 is smaller than the inner diameter of the opening 121a of the cover frame 121, and the inner peripheral surface of the opening 121a of the cover frame 121 and the outer peripheral surface 122c of the cover plate 122 are spaced apart, defining a gap G1 in which the first joining member 126 can be provided. The first joining member 126 is arranged in this gap G1, and the first joining member 126 seals the region between the inner peripheral surface of the opening 121a of the cover frame 121 and the outer peripheral surface 122c of the cover plate 122. The first joining member 126 is, for example, an annular packing member or adhesive made of rubber, elastic resin, or the like.

The outer peripheral edge portion of the main surface 122a on the front side of the cover plate 122 is supported on the back surface of the inner flange portion 1212, with the annular second joining member 127 interposed. That is, the main surface 122a of the cover plate 122 and the back surface of the inner flange portion 1212 are spaced away from each other, defining a gap G2 in which the second joining member 127 is provided. For example, an annular double-sided adhesive tape is provided in this gap G2 as the second joining member 127, and the second joining member 127 seals the region between the main surface 122a of the cover plate 122 and the back surface of the inner flange portion 1212. The second joining member 127 is, for example, an annular double-sided adhesive tape or an adhesive provided annularly. The gap G2 is continuous with the gap G1. In the continuous gaps G1 and G2, the second joining member 127 and the first joining member 126 may be continuously arranged, or they may partially overlap or may be in contact with each other.

The vibration plate 123 is arranged on the front surface side of the cover plate 122. The vibration plate 123 is a circular plate made of metal such as SUS. The vibration plate 123 has the same shape as the inner peripheral edge of the inner flange portion 1212, and has a smaller diameter than the inner peripheral edge of the inner flange portion 1212. That is, as shown in FIG. 2 and FIG. 4, the outer peripheral surface of the vibration plate 123 and the inner peripheral surface of the inner flange portion 1212 are slightly spaced apart in the radial direction, defining a gap G3. The gap G3 is continuous with the inner peripheral side of the gap G2.

The outer peripheral portion of the vibration plate 123 is joined to the surface of the cover plate 122 by a third joining member 128 made of, for example, an annular double-sided adhesive tape. The vibration plate 123 and the cover plate 122 are adhered to each other by means of the annular third joining member 128 interposed therebetween, so that they are slightly spaced apart in the axial direction. Therefore, a gap G4 is formed between the vibration plate 123 and the cover plate 122, and the entire periphery of the gap G4 is surrounded by the third joining member 128. That is, the central vibration area of the vibration plate 123 is in a state floating above the cover plate 122.

The third joining member 128 is an annular double-sided adhesive tape. For example, the third joining member 128 is arranged between the front side main surface 122a of the cover plate 122 and the back side main surface of the vibration plate 123. The outer diameter of the third joining member 128 is smaller than the inner diameter of the annular second joining member 127, and the second joining member 127 and the third joining member 128 are spaced apart from each other in the radial direction.

The piezoelectric ceramic plate 124 is provided on the main surface of the vibration plate 123. For example, the piezoelectric ceramic plate 124 is provided in a central vibration area of the vibration plate 123, at a position which is more inward than a position where the third joining member is pasted, and is located in a region corresponding to the opening of the annular third joining member. That is, the piezoelectric ceramic plate 124 is formed to have a circular shape having a smaller diameter than the inner diameter of the third joining member. For example, the piezoelectric ceramic plate 124 is pasted to the central vibration area of the vibration plate 123 by means of an adhesive. The piezoelectric ceramic plate 124 includes a piezoelectric member, is coupled, for example, to a spring provided for the watch module 20, and produces sound by vibrating in response to a signal (current) from the watch module 20. The covering plate 125 is attached to the surface of the piezoelectric ceramic plate 124 by means of the fourth joining member 129.

In this manner, the piezoelectric ceramic plate 124 provided on the main surface of the vibration plate 123 is arranged inside the cover plate 122. There is also known a device in which the vibration plate is not provided inside the cover plate but is provided at the position where the cover plate is to be provided originally, in which case the cover plate is not provided. However, this type of vibration plate is designed to be vibrated with minimal power consumption by means of a motor directly provided on the vibration plate. Since this type of vibration plate is a component that simply transmits vibration, it differs distinctly from a piezoelectric ceramic plate that produces sound. In the case of a piezoelectric ceramic plate, it must be placed inside the back cover to prevent it from breaking on impact.

The covering plate 125 is a metal plate made of SUS, for example. The covering plate 125 is formed to have the same circular shape as the front surface side of the piezoelectric ceramic plate 124 and covers that front surface side. The covering plate 125 covers the surface of the piezoelectric ceramic plate 124, so that even if the screw-back type cover frame 121 is rotated for attachment to the case body 11, the spring in contact with the piezoelectric ceramic plate 124 does not abrade the piezoelectric ceramic plate 124.

The fourth joining member 129 shown in FIG. 5 is, for example, a conductive adhesive tape. The fourth joining member is provided between the piezoelectric ceramic plate 124 and the covering plate 125, and adhesively supports the piezoelectric ceramic plate 124 and the covering plate 125 in a conductive manner.

The exterior case 13 is formed to have an annular shape and is arranged in a circular region on the front side of the peripheral wall portion 111, which is a region inward of the front end edge of the outer wall portion. For example, the exterior case 13 protects various components such as the cover 30 and supports the cover 30. The exterior case 13 is fixed to the case body 11, for example, by means of adhesive or by use of various fastening members.

The watch module 20 includes various parts necessary for the watch function, including a display section that displays information such as the time and date, a movement that operates the display section, a circuit board on which electronic components, such as an IC and an antenna, are provided, and a battery. For example, the display section may be a digital display section including a liquid crystal display panel provided with a digital display function, or may be an analog display section including a dial, hands, etc. Further, a plurality of display sections may be provided.

The cover 30 is a transparent member that is made, for example, of inorganic glass, such as SiO₂ glass. For example, the cover 30 is made of transparent circular-plate watch glass, and is arranged on the front side of the watch module 20 to cover the watch module 20. For example, the cover 30 is supported on the inner peripheral edge of the front opening of the case body 11. Packing is interposed between the outer periphery of the cover 30 and the inner peripheral edge of the case body 11.

The assembling process of the back cover portion 12 includes, for example, pasting a double-sided adhesive tape to the back surface of the inner flange portion 1212 of the cover frame 121, and press-fitting the cover plate 122 having the first joining member 126, such as a packing member, into the cover frame 121, for fixing.

The double-sided adhesive tape and the vibration plate 123 are pasted on the cover plate 122, then the piezoelectric ceramic plate 124 is adhesively fixed to the vibration plate 123, and then the covering plate 125 is pasted by means of the fourth joining member 129.

In the watch 1 and watch case 10 configured as above, the back cover portion 12 is made by combining the cover frame 121 having the opening 121a formed at the center with the cover plate 122 arranged in the opening 121a, so that radio wave sensitivity can be improved. That is, the back cover portion 12 is composed of a plurality of members which are assembled together with the gaps sealed by joining members, and the back cover portion 12 of this structure can provide an improved radio wave sensitivity as compared with a back cover portion integrally made of metal. Moreover, the use of the first joining member 126 and the second joining member 127 for fixing ensures reliable sealing performance and waterproof performance and improves impact resistance. For example, in the case of a structure in which a joining member, such as packing, is interposed only in the outer peripheral portion, it is not easy to reliably restrict vertical movement, but because of the use of the second joining member, such as a double-sided adhesive tape, between the opposing surface portions, movement can be restricted, with reliable radio wave sensitivity ensured, and impact resistance can be improved. In addition, since the outer peripheral portion is sealed with the packing and the double-sided adhesive tape is pasted to the end face side, sealing performance and radio wave sensitivity can be improved without impairing ease of assembly.

Furthermore, in the above embodiment, a gap is provided between the cover frame 121 made of metal and the vibration plate 123 made of metal. With this structure, electrical conduction between the cover frame 121 and the vibration plate 123 is prohibited, and it is possible to avoid the problem wherein resistance increases due to the integration of the cover frame 121 and the vibration plate 123, and wherein the receiving sensitivity of radio waves of a radio-controlled watch decreases. In a case where the cover frame 121 made of metal and the vibration plate 123 made of metal are integrally formed as one piece, and where the vibration plate 123 is provided above the cover frame 121, the watch 1 is inevitably thick, but this problem can also be avoided.

Furthermore, in the above embodiment, the piezoelectric ceramic plate 124 is not pasted directly to the cover plate 122 but is assembled with the vibration plate 123 interposed. Thus, reliable vibration characteristics of the piezoelectric ceramic plate 124 are ensured, and the sound pressure can be maintained.

Furthermore, a gap G4 is formed between the vibration plate 123 and the cover plate 122, and the entire periphery of the gap G4 is surrounded by the annular third joining member 128. Thus, the central vibration area of the vibration plate 123 is in a state floating above the cover plate 122, and improved vibration characteristics are ensured.

Moreover, the cover plate 122 is made of sapphire glass, so that the module breaking strength against drop impact increases, and impact resistance can be improved.

The embodiment described above is nothing but an example and in no way restricts the scope of the invention.

For example, the cover frame was described as a screw-back structure that is fastened to the case body 11, but the cover frame is not limited to this. For example, the cover frame 121 may be screwed to the case body 11. Moreover, although the cover plate 122 was described as being made of sapphire glass, it may be made of glass other than sapphire or may be made of metal.

Although the watch case 10 was described as an example of the device in connection with the above embodiment, this is not restrictive. For example, the device can be applied to any one of various devices, such as a wrist device that does not have a time function.

Although several embodiments of the present invention have been described, the specific configuration, structure, positional relationship, etc. shown in the above embodiments can be changed as appropriate without departing from the spirit of the present invention. The present invention is included within the scope of the invention described in the claims and its equivalents.

What is claimed is:

1. A device comprising:
a case body including a peripheral wall portion;
a cover frame provided on one side of the peripheral wall portion of the case body and made of a metal with an opening;
a cover plate formed to have a plate shape and arranged in the opening of the cover frame;
an vibration plate arranged on another side of the cover plate and made of metal; and
a piezoelectric ceramic plate arranged on another side of the vibration plate,
wherein
an inner peripheral surface of the opening of the cover frame and an outer peripheral surface of the vibration plate are spaced apart from each other.

2. The device according to claim 1, wherein
an inner peripheral surface of the opening of the cover frame and an outer peripheral surface of the cover plate are spaced apart from each other.

3. The device according to claim 1, further comprising:
a first joining member arranged between an inner peripheral surface of the opening of the cover frame and an outer peripheral surface of the cover plate; and
a third joining member arranged between a main surface on another side of the cover plate and a main surface on one side of the vibration plate and formed to be annular,
wherein
a gap is formed between the vibration plate and the cover plate in an opening of the third joining member.

4. The device according to claim 2, further comprising:
a first joining member arranged between an inner peripheral surface of the opening of the cover frame and an outer peripheral surface of the cover plate;
a third joining member arranged between a main surface on another side of the cover plate and a main surface on one side of the vibration plate and formed to be annular,
wherein
a gap is formed between the vibration plate and the cover plate in an opening of the third joining member.

5. The device according to claim 3, wherein:
the piezoelectric ceramic plate is provided on a main surface on another side of the vibration plate and in a region corresponding to the opening of the annular third joining member.

6. The device according to claim 4, wherein
the piezoelectric ceramic plate is provided on a main surface on another side of the vibration plate and in a region corresponding to the opening of the annular third joining member.

7. The device according to claim 5, further comprising:
a conductive adhesive tape arranged on another side of the piezoelectric ceramic plate; and
a covering plate arranged on another side of the piezoelectric ceramic plate, with the conductive adhesive tape interposed.

8. The device according to claim 6, further comprising:
a conductive adhesive tape arranged on another side of the piezoelectric ceramic plate; and
a covering plate arranged on another side of the piezoelectric ceramic plate, with the conductive adhesive tape interposed.

9. The device according to claim 7, wherein
the cover frame includes an annular frame base arranged opposite to an outer periphery of the cover plate, and an inner flange portion that protrudes inward from the annular frame base into an opening and is arranged overlapping another side of a peripheral edge of the cover plate, and
a gap is formed between an inner peripheral edge of the inner flange portion and an outer peripheral edge of the vibration plate.

10. The device according to claim 8, wherein
the cover frame includes an annular frame base arranged opposite to an outer periphery of the cover plate, and an inner flange portion that protrudes inward from the annular frame base into an opening and is arranged overlapping another side of a peripheral edge of the cover plate, and
a gap is formed between an inner peripheral edge of the inner flange portion and an outer peripheral edge of the vibration plate.

11. The device according to claim 9, wherein
the cover frame includes a recess formed along a peripheral direction at a base end corner of the frame base and the inner flange portion.

12. The device according to claim 10, wherein
the cover frame includes a recess formed along a peripheral direction at a base end corner of the frame base and the inner flange portion.

13. The device according to claim 9, further comprising:
a second joining member arranged between the inner flange portion of the cover frame and the cover plate,
wherein the cover plate and the first joining member are in contact with the second joining member.

14. The device according to claim 10, further comprising:
a second joining member arranged between the inner flange portion of the cover frame and the cover plate,
wherein the cover plate and the first joining member are in contact with the second joining member.

15. The device according to claim 1, wherein
the cover frame is a screw back type, and
the cover plate includes sapphire glass.

16. The device according to claim 2, wherein
the cover frame is a screw back type, and
the cover plate includes sapphire glass.

17. The device according to claim 3, wherein
the cover frame is a screw back type, and
the cover plate includes sapphire glass.

18. The device according to claim 4, wherein
the cover frame is a screw back type, and
the cover plate includes sapphire glass.

19. A watch comprising:
a device as recited in claim 1;
a watch module arranged in a housing portion formed inward of the peripheral wall portion of the case body; and
a cover covering another side of the watch module.

20. A watch comprising:
a device as recited in claim 2;
a watch module arranged in a housing portion formed inward of the peripheral wall portion of the case body; and
a cover covering another side of the watch module.
